(19) United States
(12) Patent Application Publication
(10) Pub. No.: US 2022/0329101 A1
(43) Pub. Date: Oct. 13, 2022

(54) METHOD AND SYSTEM FOR ESTIMATION AND MONITORING OF DISTRIBUTED NETWORK CONDITIONS

(71) Applicant: Danmarks Tekniske Universitet, Kgs. Lyngby (DK)

(72) Inventors: Theis Bo Rasmussen, Solrød Strand (DK); Guangya Yang, Charlottenlund (DK)

(21) Appl. No.: 17/620,980

(22) PCT Filed: Jun. 23, 2020
(86) PCT No.: PCT/EP2020/067457

§ 371 Date: Dec. 20, 2021

(30) Foreign Application Priority Data
Jun. 24, 2019 (EP) 19182001.8

(51) Int. Cl. H02J 13/00; H02J 3/38

(52) U.S. Cl. CPC H02J 13/00034; H02J 13/00002; H02J 3/381; H02J 2300/24

(57) ABSTRACT

A method/system is provided for estimating distribution system conditions in a low-voltage network having local nodes, the local nodes including distributed energy resources. The method includes: acquiring periodic measurements of periodic node voltages and/or branch currents from nodes, the measurements acquired with fixed time intervals; acquiring event-driven measurements of event-driven data based on node voltages and/or branch currents from the energy resources and/or other event-driven data sources, the measurements acquired when a power operating point and/or other measured quantity changes exceed a predefined threshold; in a primary process, executing a distribution system state estimation based on a data set including the periodic measurements; in a secondary process, estimating impacts on the node voltages and/or branch currents in local nodes based on the event-driven measurements; wherein the estimated impacts on node voltages and/or branch currents in local nodes from the secondary process update the data set in the primary process.

### CROSS REFERENCE TO RELATED APPLICATIONS

This application is the U.S. National Stage of PCT/EP2020/067457 filed Jun. 23, 2020, which claims the priority of European Patent Application 19182001.8 filed Jun. 24, 2019, the entire contents of both are incorporated herein by reference in its entirety.

The present disclosure relates to a method of estimating distribution system conditions in low-voltage networks. The disclosure further relates to a system in the form of a bi-level estimation platform for estimation of operating conditions of low-voltage network feeder conditions.

### BACKGROUND OF INVENTION

Electric power distribution systems are designed to serve their users with power. A low-voltage network or secondary network is a part of electric power distribution which carries electric energy from distribution transformers to electricity meters of end users. These networks are operated at a low voltage level, typically mains voltage.

Traditional consumption has been unidirectional and limited by fuse ratings of electrical installations. Under these conditions, design of distribution networks has been straightforward. No real need for advanced monitoring of operational conditions existed. However, with the introduction of distributed energy resources (DER), such as roof-top solar photovoltaic (PV) plants, electric vehicles (EV) and heat pumps (HP), the volatility of operation in the electric power distribution systems has increased.

For this reason distribution network operators have an increasing need to closely monitor the operational conditions. Low-voltage network monitoring has become critical for the implementation of smart grid technologies, which enables control and coordination of distributed energy resources. These technologies require sensible monitoring of the network operating conditions in order to avoid violations of voltage and current limits.

The characteristics of distribution networks differ from transmission networks in that many distribution networks have a radial construction, in that they often have more measurement points, in that the measurements are not necessarily direct voltage and current measurements and in that they may have significant phase imbalances. Distribution system state estimation (DSSE) itself is a well-known concept within electric power distribution systems and therefore not explained in detail in the present application.

More recently, the conventional residential meters have been replaced in large parts of Europe, America and Asia by smart meters. The smart meters enable digital measurements and automatic communication of data to the utilities. Typically, the distributed energy resources also have embedded measurement and communication functions. The deployment of smart meters and distributed energy resources have increased the number of observation points that can be utilized in distribution network monitoring.

For the presently available low-voltage network monitoring there are a number of challenges. The distribution system state estimation (DSSE) requires a considerable amount of time to execute. Delay caused by such computations means less valuable results since the system is dynamic. Another issue is that the data sets may be incomplete for various reasons, including communication reliability issues and confidentiality concerns, hence existing monitoring solutions require heavy investments in in information and communication technology (ICT).

### SUMMARY OF INVENTION

Accordingly, it is an object of the present disclosure to overcome one or more of the above mentioned disadvantages of the existing methods and systems. The present disclosure relates to, in a first embodiment, a method for estimating distribution system conditions of a low-voltage network of a distribution system, said low-voltage network having a plurality of local nodes, wherein one or more of the local nodes comprise distributed energy resources, the method comprising:

acquiring periodic measurements of periodic node voltages and/or branch currents from one or more of the local nodes in the low-voltage network;
acquiring event-driven measurements of event-driven data based on node voltages and/or branch currents from the distributed energy resources and/or other event-driven data sources;
in a primary process, executing a distribution system state estimation for the low-voltage network based on a data set comprising the periodic measurements;
in a secondary process, estimating impacts on the node voltages and/or branch currents in the plurality of local nodes based on the event-driven measurements;
wherein the estimated impacts on the node voltages and/or branch currents in the plurality of local nodes from the secondary process are used to update the data set in the primary process.

The method is based on processing of measurements through distinction between data sources. The method can be used to utilize existing information and communication infrastructure to access periodic and event-driven data from smart meters and distributed energy resources. The method inherently compensates for incomplete datasets by performing an event-driven update of network conditions. The event-driven data is data acquired when a power operating point and/or other measured quantity changes more than a predefined threshold for one of the distributed energy resources. The event-driven data is based on node voltages and/or branch currents from the distributed energy resources and/or other event-driven data sources. Typically, the event-driven data comprises active and reactive power injection and/or the voltage magnitude from the distributed energy resources. The method can be implemented in a platform that can be installed in a secondary substation cabinet at the low-voltage side of the transformer without the need for additional ICT investment. The method may be referred to as a bi-level processing method due to the primary and secondary processes.

A three-phase DSSE algorithm may be executed using acquisition of periodic smart meter readings. As mentioned, one challenge is to ensure high data quality due to operational issues and confidentiality issues. In the presently disclosed method, a second processing layer may use event-driven measurements from DERs update to estimate impacts on the node voltages and/or branch currents in the local nodes. In contrast to the DSSE, these updates may be substantially real-time and may be used improve the datasets of the primary process. The output of the secondary process may be provided in network conditions as ranges rather than specific values. The updated view on network conditions form the secondary process may be used to ensure high-quality data input to the estimation of the primary process.

In one embodiment, the step of estimating impacts in the secondary process is performed upon execution of the distributed system state estimation in the primary process in order to re-evaluate the distributed system state estimation for the low-voltage network.

In one embodiment, the secondary process is used to update the data set in the primary process, taking into account operating conditions in the low-voltage network and adding missing data to the data set.

The present disclosure further relates to a monitoring system for estimation and monitoring of low-voltage network feeder operating conditions, comprising:

at least a communication unit configured for:
a. acquiring periodic measurements of periodic node voltages and/or branch currents from one or more local nodes in the low-voltage network;
b. acquiring event-driven measurements of event-driven node voltages and/or branch currents from one or more distributed energy resources in the low-voltage network;
at least a processing unit configured for:
c. in a primary process, executing a distributed system state estimation for the low-voltage network based on a data set comprising the periodic measurements;
d. in a secondary process, estimating impacts on the node voltages and/or branch currents in the local nodes based on the event-driven measurements;
wherein the estimated impacts on the node voltages and/or branch currents in the local nodes from the secondary process are used to update the data set in the primary process.

The system may be implemented on two processors, wherein a first processing unit is configured for handing the primary process and a second processing unit is configured for handling the secondary process. The distribution system monitoring system may be implemented in secondary substations where low-voltage (LV) radial feeders are connected to the higher voltage level distribution network. It may comprise a configuration of the data source (smart meters, DERs) transmission settings and a routing of the information flow to the distribution network operator.

These and other aspects of the invention are set forth in the following detailed description of the invention.

### DESCRIPTION OF DRAWINGS

FIG. 1 shows an example of acquisition of periodic and event-driven measurements.

FIG. 2 shows a possible implementation of the presently disclosed method and platform in a secondary substation cabinet.

FIG. 3 shows an embodiment of the steps of the presently disclosed method of estimating distribution system conditions in a low-voltage network.

FIG. 4 shows an embodiment of the presently disclosed distribution system monitoring system for estimation of operating conditions of low-voltage network feeder conditions.

FIG. 5 shows an example of low-voltage network having a low-voltage feeder and a number of local nodes.

FIG. 6 shows impacts on the node voltage in one of the local nodes, computed by the secondary process, and DSSE, computed by the primary process.

FIG. 7 shows a further example of impacts on the node voltage in one of the local nodes, computed by the secondary process, and DSSE values, computed by the primary process.

FIG. 8 shows a comparison of individually/stand-alone estimated ranges (8A) and narrower estimates through aggregation of estimates within a 1-minute time period (8B). The comparisons are shown as a number of quantiles for the two approaches.

### DETAILED DESCRIPTION OF THE INVENTION

The present disclosure relates to a method of estimating distribution system conditions of a low-voltage network of a distribution system. The low-voltage network has a plurality of local nodes, wherein the local nodes may comprise both smart meters and distributed energy resources. The method comprises at least the steps of:

acquiring periodic measurements of periodic node voltages and/or branch currents from one or more of the local nodes in the low-voltage network; and

acquiring event-driven measurements of event-driven data based on node voltages and/or branch currents from the distributed energy resources and/or other event-driven data sources.

The steps do not have to be sequential, but may be executed in parallel and triggered by periodic measurements and events, respectively.

State estimation is crucial in the development of models for power system monitoring and analysis. Power System State Estimation (PSSE) is a well-known concept, which has been researched and applied in power transmission systems since the 1970s. The need for Distribution system state estimation (DSSE) is important since the introduction of distributed energy resources (DER), such as roof-top solar photovoltaic (PV) plants, electric vehicles (EV) and heat pumps (HP), has increased the volatility of operation in the electric power distribution systems. As would be appreciated by a person skilled in the art, the term distribution system state estimation (DSSE) is well-known in the field. The person skilled in the art will thus also understand what it means to execute a distribution system state estimation. The present disclosure provides a number of examples of specific estimations of a distribution system state.

As described in further detail below, the present disclosure bi-level processing method and platform for estimation of distribution network condition may operate through application of DSSE, wherein both periodic and event-driven measurements are used in a two-layered data processing strategy. On one level, in a primary process, a three-phase DSSE algorithm may be executed using acquisition of periodic smart meter readings. In the second processing layer, in a secondary process, event-driven measurements from DERs are processed after acquisition. This event-driven update of network conditions may provide a potentially substantially real-time monitoring and may capture system dynamics, which can be used by the operator for LV as input to control decision making. One embodiment of the presently disclosed method therefore further comprises the step of communicating the estimated network conditions to a central entity of a power distribution network operator. The estimation may comprise an estimation of the operation range of three-phase network and current. The DSSE may be a three-phase DSSE. Variables of interest when estimating distribution system conditions may be indicative of, for example, parameters like margins to operating limits. State estimators allow the calculation of these variables of interest. The state estimator is an integral part of the overall monitoring and control systems for a network. It is mainly aimed at providing a reliable estimate of the system currents/voltages.

The second layer processing may involve an interval-arithmetic consideration of measurement inaccuracy and a calculation of the impact on branch currents and/or node voltages. With the interval-arithmetic approach, the network conditions may be given as a range rather than a specific value. This has the benefit of giving an indication of uncertainty not provided by DSSE itself, which typically provides deterministic results. In one embodiment of the presently disclosed method, the step of estimating impacts on the node voltages and/or branch currents in the local nodes comprises estimating voltage magnitude ranges and or branch current ranges for all local nodes of the low-voltage network.

In the primary process, a distributed system state estimation may be executed for the low-voltage network based on a data set comprising the periodic measurements. The DSSE execution may take a considerable amount of time, in particular if implemented on a relatively low-cost processor. The DSSE result may therefore represent the estimated network conditions at the time when the process was started since the dataset was acquired at that time. According to one embodiment of the presently disclosed method, the step of estimating impacts in the secondary process is performed upon execution of the distributed system state estimation in the primary process in order to re-evaluate the distributed system conditions for the low-voltage network.

In the secondary process, impacts on the node voltages and/or branch currents may be estimated in the local nodes based on the event-driven measurements. The estimated impacts on the node voltages and/or branch currents in the local nodes from the secondary process may be used to update the data set in the primary process. The combination of two processing layers can be used to update results that can replace missing entities in the periodic DSSE data set. Therefore, in one embodiment, the estimated impacts from the secondary process are used to supplement incomplete data sets in the primary process.

One advantage of the present invention is that it can be implemented as a platform directly in a secondary substation cabinet utilizing the existing infrastructure. Therefore, the periodic and/or event-driven measurements may be acquired in the secondary substation cabinet, wherein the primary and secondary processes are also performed in the secondary substation cabinet. The periodic and/or event-driven measurements may be acquired using for example power line carrier and/or cellular and/or radio frequency communication. Additional sensor readings of systems that affect the network conditions can be included. These sensors include IoT sensors of traffic and residential activities, as well as weather sensors and forecasts. With the addition of more sensors, the event-driven updates of network conditions may be more frequent, meaning the network conditions can be monitored with higher granularity.

Most European smart meters form data packages according to the DLMS/COSEM protocol and are primarily used for electrical billing purposes. Adjusting the DLMS/COSEM settings through the OBIS codes allow customizing the data package content and the communication settings, meaning the smart meters can be adjusted to fit additional applications.

Periodic transmission option enables synchronous data acquisition. The synchronous acquisition is valuable in processing data as complete data sets are updated in a periodic fashion, which alleviates the need for aligning the information and simplifies the evaluation of historic data. Such option may be initiated by the periodic triggering of a timer inside the smart meter with a custom time-interval. Therefore, in one embodiment, the step of acquiring periodic measurements is triggered by a timer in fixed time intervals.

While the installation of DERs stretches across multiple technologies and numerous manufacturers, international efforts are made to ensure technology and manufacturer neutral standards. The IEEE 1547 aims to standardize interconnection and interoperability requirements of DER capabilities and the IEC 61850 aims to standardize the communication between distributed IEDs and digital substations. In one embodiment of the presently disclosed method of estimating distribution system conditions of a low-voltage network, the distributed energy resources comprise at least one photovoltaic plant and/or at least one battery and/or at least one electric vehicle. These DERs may use some of the above standards to transfer data to the presently disclosed method and system. Event-driven measurements will typically be acquired when a power operating point and/or other measured quantity changes more than a predefined threshold for one of the distributed energy resources.

Upon acquisition of event-driven measurements, the changed physical conditions may be evaluated through an estimation of the resulting change in network branch currents. These changes can be evaluated to update voltage magnitude ranges of all local nodes within the network. This can be used to replace missing data in the primary process, thereby ensuring that the DSSE is given a complete data set every time it executes. The utilization of such regularly updated pseudo measurements, that do not depend on the integrity and availability of historic information, entails a consideration of network operation compared to using either forecasts or historic data directly. As stated above, when the DSSE execution finishes, event-driven updates performed during the DSSE execution may be re-evaluated in the secondary process with the new DSSE results.

For each node in a radial feeder of the low-voltage network, the DSSE data set in the primary process may include three measurements for each of the three phases, that is active and reactive power injection, and the voltage magnitude. Similarly, the received estimated impacts from the secondary process may comprise active and reactive power, and voltage magnitude for all connected phases. The step of executing the distributed system state estimation may comprise an estimation of three-phase conditions of the low-voltage network. The step of executing the distributed system state estimation may also comprise an estimation of voltage phasors and branch current phasors in the local nodes. The step of executing the distributed system state estimation may also comprise an estimation of voltages and/or currents and/or consumption and/or generation of power in the local nodes. The DSSE may typically run based on reception of periodic measurements. Hence, in one embodiment of the presently disclosed method of estimating distribution system conditions of a low-voltage network, the step of executing the distributed system state estimation in the primary process is performed upon every reception of periodic measurements.

The secondary process uses the event-driven measurements. The secondary process is typically much faster than the primary process. The step of estimating impacts on the node voltages and/or branch currents in the local nodes in the secondary process may be substantially real-time. The secondary process may involve inclusion of forecasted information. Hence, in one embodiment of the presently disclosed method, the step of estimating impacts on the node voltages and/or branch currents in the local nodes in the secondary process comprises information from forecasts. The step of estimating impacts on the node voltages and/or branch currents in the local nodes in the secondary process may be performed individually for every change of power operating point and/or other measured quantity more than a predefined threshold for one of the distributed energy resources. During a DSSE, a number of updates in the secondary may therefore be processed and accumulated in parallel and taken into account in the primary process when the DSSE has finished.

The periodically acquired information may be sent to a data set formulation process before being used in the DSSE execution since there is a risk of missing data. Besides the periodic readings that arrive at the platform, the data set may be formulated through the inclusion of network condition information that is updated when event-driven measurements are processed in the secondary process. With the acquisition of event-driven measurements, the changed physical conditions may be evaluated through estimating the resulting change in network branch currents. Based on these the voltage magnitude interval of all phases and nodes within the network can be updated. In one embodiment of the presently disclosed method, the primary process comprises the step of formulating the data set based on the periodic measurements. The primary process may further comprise the step of adding missing data based on the secondary process. The replacement of missing measurements in the data set formulation ensures that the DSSE is given a complete data set every time it executes.

The present disclosure further relates to a method for monitoring of a low-voltage network of a distribution system comprising the method of estimating distribution system conditions. The monitoring may include an estimation of the operation range of three-phase network and current.

The presently disclosed method may be implemented as a computer program. The computer program has instructions which when executed by a computing device or system causes the computing device or system to perform a distribution system state estimation. The computer program may run on the presently disclosed monitoring or estimation platform.

The present disclosure further relates to a monitoring system for estimation and monitoring of low-voltage network feeder operating conditions, comprising:

at least a communication unit configured for:

a. acquiring periodic measurements of periodic node voltages and/or branch currents from one or more local nodes in the low-voltage network;
b. acquiring event-driven measurements of event-driven node voltages and/or branch currents from one or more distributed energy resources in the low-voltage network;

at least a processing unit configured for:

a. in a primary process, executing a distributed system state estimation for the low-voltage network based on a data set comprising the periodic measurements;
b. in a secondary process, estimating impacts on the node voltages and/or branch currents in the local nodes based on the event-driven measurements;
c. wherein the estimated impacts on the node voltages and/or branch currents in the local nodes from the secondary process are used to update the data set in the primary process.

The monitoring system may be adapted to carry out any embodiment of the presently disclosed distribution system estimation or monitoring method. The system may be adapted to be installed in a secondary substation cabinet, preferably at the low-voltage side of a distribution transformer of the low-voltage network. The primary and secondary processes may run on two different processing units: a first processing unit and a second processing unit. The monitoring platform may be implemented at secondary substations where low-voltage radial feeders are connected to the higher voltage level distribution network. It may require a configuration data source transmission settings i.e. smart meters and DERs and a routing of the information flow.

### DETAILED DESCRIPTION OF DRAWINGS

The invention will in the following be described in greater detail with reference to the accompanying drawings. The drawings are exemplary and are intended to illustrate some of the features of the presently disclosed method and system for estimation and/or monitoring of a low-voltage network, and are not to be construed as limiting to the presently disclosed invention.

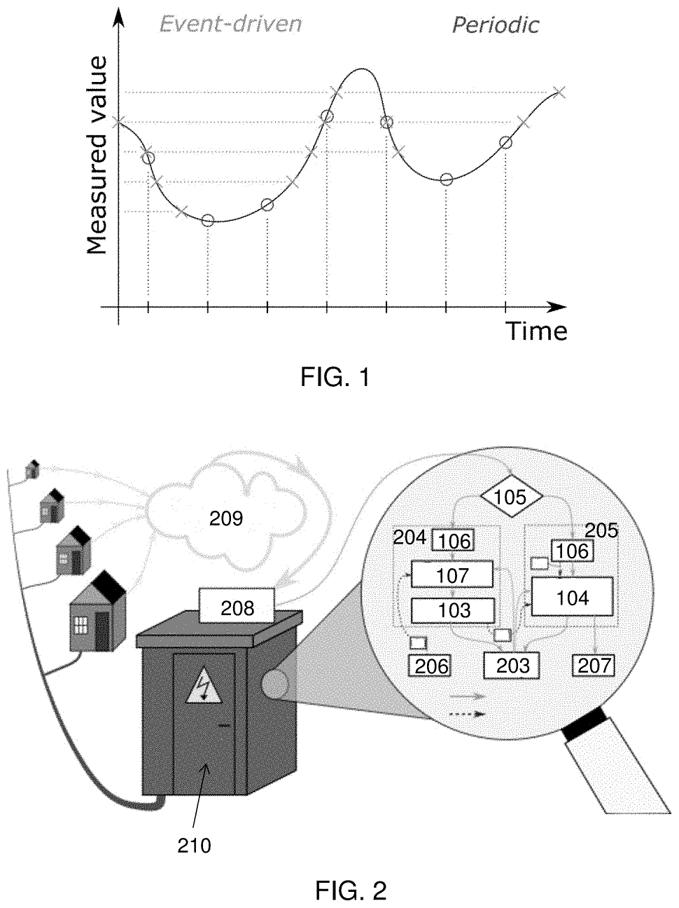

FIG. 1 shows an example of acquisition of periodic and event-driven measurements. The ‘X’s indicate event-driven measurement, which are typically asynchronous and triggered by events in the network. The ‘O’s indicate periodic measurements which are typically synchronous and may be triggered by, for example, an internal timer.

FIG. 2 shows a possible implementation of the presently disclosed method and platform in a secondary substation cabinet (210) (LV/MV substation). A data concentrator (208) bundles data from multiple sources. The low voltage network has a local communication infrastructure (209) for communication of data to/from the presently disclosed system. As shown in the flowchart, the gathered measurements are initially sorted (105) as periodic and event-driven acquisitions and used in the execution of the two processing units (204, 205). A first processing unit (204) is responsible for DSSE execution (103). A second processing unit (205) is responsible for updating the network conditions (104) through estimation of impacts. Both processing units includes buffering (106) of the incoming data. Periodically acquired information is send to the data set formulation process (107) before being used in the DSSE execution since there is a risk of missing data for the DSSE process. The acquisition of periodic measurements is triggered by an internal timer (206). Data from the second processing unit can also be sent to an output collection unit (207). Besides the periodic readings that do arrive at the platform, the data set is formulated through the inclusion of network condition information that is updated when event-driven measurements are routed through processor 2 (205). With the acquisition of event-driven measurements, the changed physical conditions are evaluated through estimating the resulting change in network branch currents. The results and/or any intermediate results may be stored in an internal storage device (203). These are analyzed to update the voltage magnitude interval of all phases and nodes within the network. Solid line arrows in FIG. 2 denote information flow. Dotted line arrows denote trigger flows.

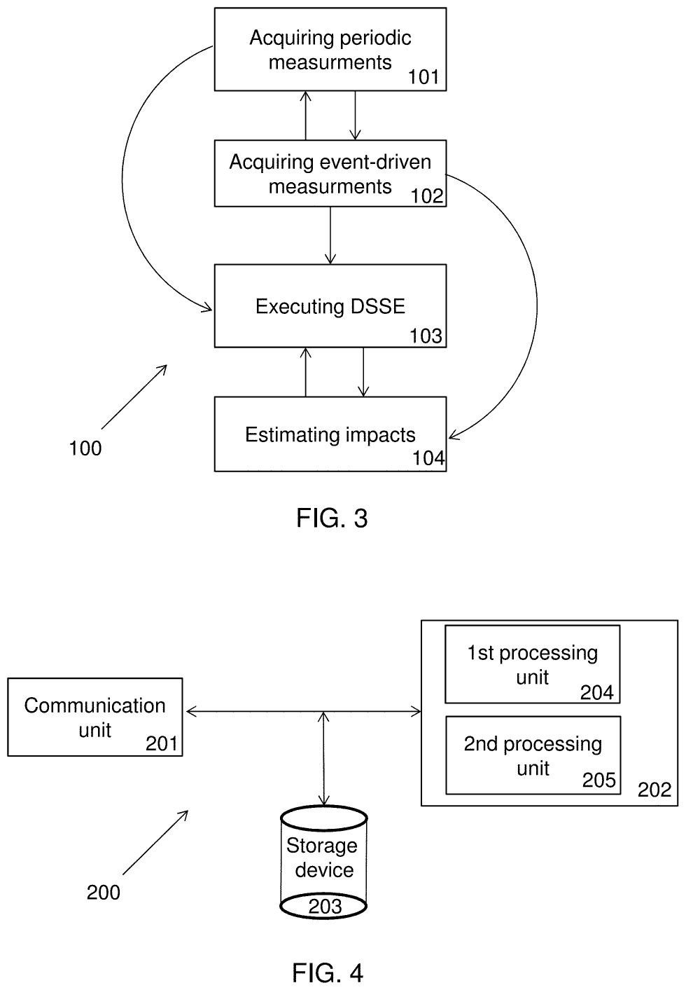

FIG. 3 shows an embodiment of the steps of the presently disclosed method (100) of estimating distribution system conditions, in particular of a low-voltage network. The processes, acquisition of periodic measurements (101) and acquisition of event-driven measurements (102) are executed. The acquisition of periodic measurements (101) may trigger the DSSE execution (103). The acquisition of event-driven measurements (102) may trigger the estimation of impacts (104). The estimated impacts (104) may be used in the DSSE execution (103). When a DSSE (103) has been finished it may trigger an update of impact estimation (104).

FIG. 4 shows an embodiment of the presently disclosed distribution system monitoring system (200) for estimation of operating conditions of low-voltage network feeder conditions. The system has a communication unit (201) for communication, such as wireless communication, with smart meters and DERs. The communication unit (201), or a different communication unit, may also be responsible for communicating the distribution system conditions to a central entity of a power distribution network operator. At least a processing unit (202) may execute the method and/or computer program. The processing unit (202) may have a dedicated first processing unit (204) for carrying out the primary process and a dedicated second processing unit (205) for carrying out the secondary process. The result and/or any intermediate results may be stored in a storage device (203). As a person skilled in the art would recognize, the system may further comprise other peripherals for handling data and communication.

### Example

The invention will in the following be described in a non-limiting example of an implementation.

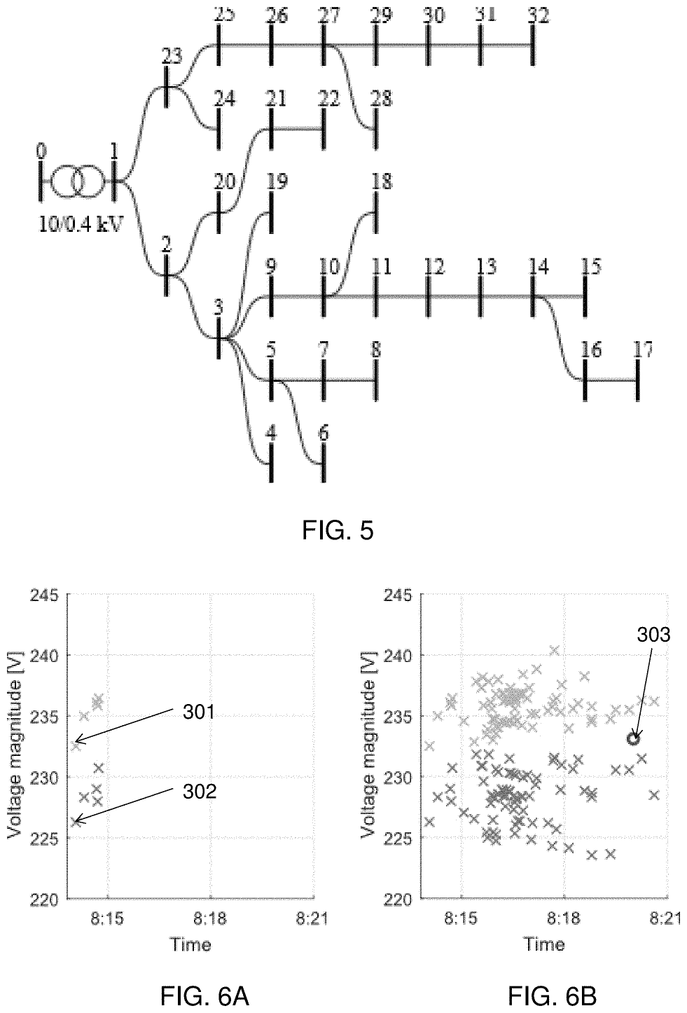

In one example the presently disclosed method and/or system is implemented in MATLAB and tested with a simulation of a LV distribution feeder according to FIG. 5. Both residential consumption and DERs may be present in the nodes. The distribution of DERs represents a future scenario where 100% of the households have installed energy systems consisting of a PV plant and a battery storage unit. The batteries are assumed to store excess PV production and discharge when household consumption exceeds the local production. Furthermore, approximately 68% of the residential load points are assumed to have EVs connected.

All loads are considered three phase and operate in unbalanced conditions. Each EV is considered to charge through three-phase chargers with rated currents of either 16 or 32 A. All PV plants and batteries are rated at 5 kVA and are set to operate with cos ϕ(P) reactive power following a linear relationship from unity power factor at 50% rated active power to 0.9 lagging power factor, from a generator perspective, at 100% rated active power. Furthermore, the event-based DER readings are send every time the active power operating point changes with more than predefined thresholds. These thresholds are assumed ±50 W for PV plants and batteries, and ±100 W for the EV chargers. For the latter DER type, the threshold is chosen arbitrarily as the EV chargers are modelled to either charge at 0 or 100% of the rated charging current. For both PV and battery inverters, the sensitivity threshold is chosen equal to the assumed metering accuracy of ±1% of the rated power. In the following simulation based scenarios, all load points and DERs are assumed to follow generic load and generation curves that are randomized for the different distributed units.

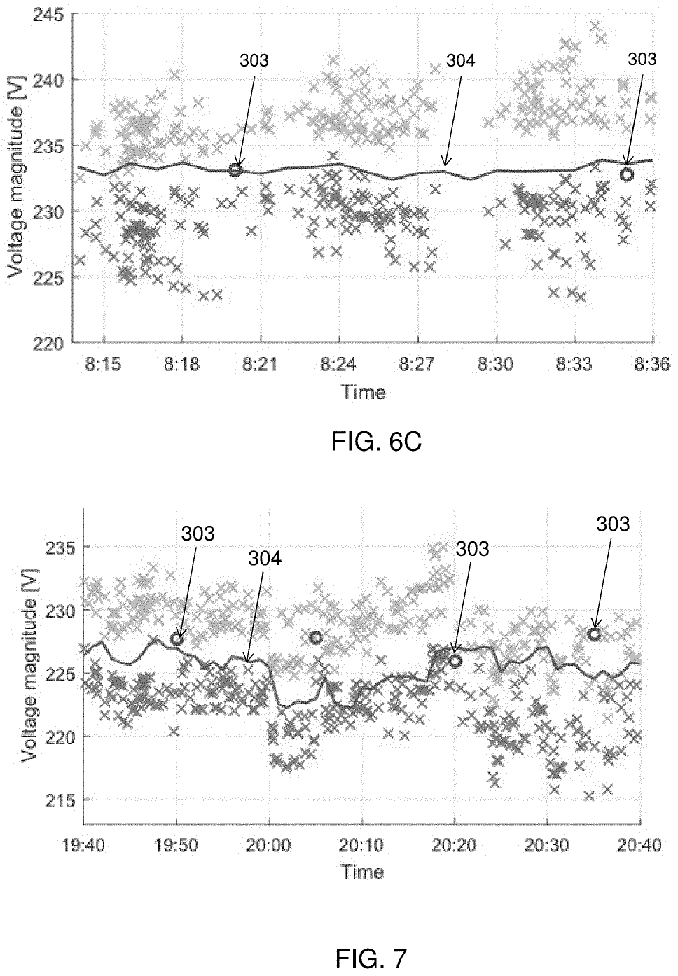

The demonstration of the proposed platform implemented for monitoring the LV feeder in FIG. 5 is performed at a time interval between 8:14 and 8:36 of the described simulation study. As the DSSE is considered executed periodically every 15th minute, this demonstration contains two executions of processor 1. Furthermore, a 1% probability of data loss is assumed meaning there is a 1% risk of losing the periodic and event-driven measurements as these are send through the ICT infrastructure. The objective of this demonstration is to illustrate how the bi-level configuration of the proposed platform enables LV network monitoring with limited processing capabilities. This is highlighted by showing the estimated conditions in a time series plots at time instances where the DSSE algorithm on processor 1 is initiated and when it has finished its execution. To demonstrate this capability, an observation of the node 6 phase a voltage magnitude is shown in FIG. 6. The illustrations in FIG. 6A-B are zoomed to the time interval between 8:14 and 8:21, and FIG. 6A show the first 5 estimated ranges between 8:14 and 8:15. The ‘X’ 301 and 302 denotes the upper and lower boundaries of the first range. These are calculated from the reporting of updated conditions of 5 PV plants at nodes 14, 26, 21, 2, and 31, meaning their active power generation has changed relative to the previously reported conditions by a quantity larger than the predefined threshold as explained with the event-driven transmission setting in FIG. 1. At 8:15, the platform timer triggers processor 1 to start executing the DSSE algorithm. With limited processing power, the DSSE execution takes a considerable amount of time as seen by the time difference between the DSSE start time 8:15 and the return of the deterministic voltage magnitude estimate represented by the circle ‘O’ (303) in FIG. 6B at approximate 8:20. It is worth remembering that the deterministic DSSE results represent the estimated network conditions at 8:15 because the input data set is based on periodic metering acquisition at 8:15. In addition, FIG. 6C show how the proposed platform is capable of estimating voltage magnitude intervals during the DSSE execution because of the bi-level processing architecture. The complete time series from 8:14 to 8:36 used in this demonstration is shown in FIG. 6C together with the power flow voltage profile results (304). Here the power flow results are calculated every minute, between which the conditions are assumed to follow a linear relationship. In the illustrated time period, two DSSE executions are initiated at 8:15 and 8:30, and finishes approximately 6 minutes after. For the first DSSE result representation, the power flow voltage profile at 8:20 looks accurately estimated. However, the DSSE estimation results represent the 8:15 power flow conditions and a careful investigation shows a small estimation error is visible. The same conditions apply for the evaluation of the second DSSE execution. For the demonstrated time series, the network conditions are not severely volatile. But in modern distribution networks, with many DG and electrified services, the changes can be severe as seen in the illustration of node 6, phase a time series between 19:40 and 20:40 shown in FIG. 7.

Evaluating the performance of the developed bi-level processing platform for LV network monitoring is done through analyzing its ability to contain the voltage magnitude at all nodes and phases during a single day of operation. The performance is therefore evaluated through the statistics of the estimated range at all nodes and phases in the network. Furthermore, the information availability limitations are considered through analyzing the platform performance with different scenarios of data loss probability. A statistical overview of the platform performance compared to that of the processor 1 DSSE algorithm itself is given in Table 1.

TABLE 1

| | Registered | | | | | | | |
|---|---|---|---|---|---|---|---|---|
| | DER | | Bi-level platform | | | Processor 1 DSSE | | |
| Data loss | changes | Interval | | | Max. | | | Max. |
| probability | (Intervals) | errors | V error <1% | V error >1% | error | V error <1% | V error >1% | error |
| 0% | 16,061 | 18,503 | 97.76% | 2.24% | 5.73 V | 90.87% | 9.13% | 12.48 V |
| | (1,541,856) | (1.20%) | | | (2.48%) | | | (5.40%) |
| 1% | 15,890 | 20,716 | 97.86% | 2.14% | 5.08 V | 90.52% | 9.48% | 12.39 V |
| | (1,525,440) | (1.36%) | | | (2.20%) | | | (5.37%) |
| 5% | 15,254 | 28,229 | 96.75% | 3.25% | 5.85 V | 89.01% | 10.99% | 12.59 V |
| | (1,464,384) | (1.93%) | | | (2.53%) | | | (5.45%) |
| 10% | 14,482 | 31,438 | 95.07% | 4.93% | 5.75 V | 88.04% | 11.96% | 12.75 V |
| | (1,390,272) | (2.26%) | | | (2.49%) | | | (5.52%) |
| 25% | 12,014 | 72,433 | 87.62% | 12.38% | 9.78 V | 78.79% | 21.21% | 14.91 V |
| | (1,153,344) | (6.28%) | | | (4.23%) | | | (6.46%) |

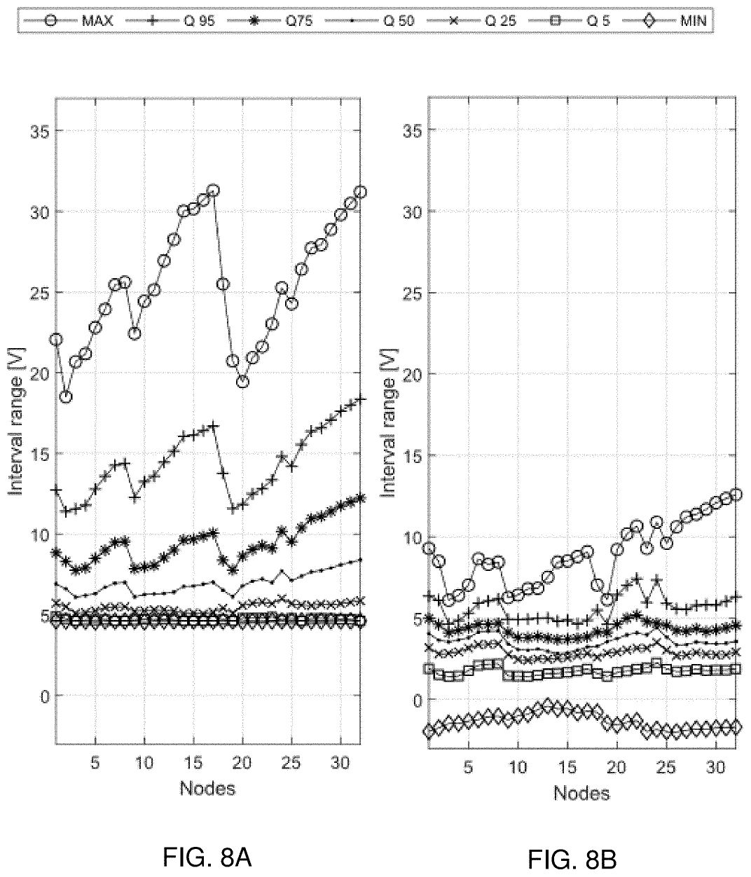

FIG. 8 shows a comparison of individually/stand-alone estimated ranges (8A) and narrower estimates through aggregation of estimates within a 1-minute time period (8B). The comparisons are shown as a number of quantiles for the two approaches.

In FIG. 8A individually estimated ranges are considered. In FIG. 8B a narrower estimate is considered through aggregation of estimates within 1-minute time periods.

A direct comparison between the stand-alone estimated ranges in FIG. 8A and those aggregated across a 1-minute resolution in FIG. 8B, reveals several characteristics. First of all, more than 95% of all estimated intervals have a voltage magnitude range narrower than 10% of rated LV network voltage magnitude, equal to 23.1 V. Secondly, the narrowest possible range of estimated intervals at any node in the network is approximately 2% of the rated voltage i.e. 5 V corresponding to the metering infrastructure accuracy of ±1% of rated voltage. Thirdly, the aggregated intervals have much narrower voltage magnitude range, and finally, in less than 5% of the aggregated intervals the minimum boundary is lower than the maximum boundary seen as negative interval ranges in FIG. 8B.

### Further Details of the Invention

1. A method of estimating distribution system conditions in a low-voltage network of a distribution system, said low-voltage network having a plurality of local nodes, wherein one or more of the local nodes comprise distributed energy resources, the method comprising:
   acquiring periodic measurements of periodic node voltages and/or branch currents from one or more of the local nodes in the low-voltage network;
   acquiring event-driven measurements of event-driven data based on node voltages and/or branch currents from the distributed energy resources and/or other event-driven data sources;
   in a primary process, executing a distribution system state estimation for the low-voltage network based on a data set comprising the periodic measurements;
   in a secondary process, estimating impacts on the node voltages and/or branch currents in the plurality of local nodes based on the event-driven measurements;
   wherein the estimated impacts on the node voltages and/or branch currents in the plurality of local nodes from the secondary process are used to update the data set in the primary process.
2. The method according to item 1, wherein the step of estimating impacts on the node voltages and/or branch currents in the plurality of local nodes comprises estimating voltage magnitude ranges and or branch current ranges for all of the plurality of local nodes.
3. The method according to any of the preceding items, wherein the estimated impacts from the secondary process are used to supplement incomplete data sets in the primary process.
4. The method according to any of the preceding items, wherein the step of acquiring periodic measurements is triggered by a timer in fixed time intervals.
5. The method according to any of the preceding items, wherein the periodic measurements are acquired from smart meters in one or more of the local nodes.
6. The method according to any of the preceding items, wherein the distributed energy resources comprise at least one photovoltaic plant and/or at least one battery and/or at least one electric vehicle.
7. The method according to any of the preceding items, wherein an event-driven measurement is acquired when a power operating point and/or other measured quantity changes more than a predefined threshold for one of the distributed energy resources.
8. The method according to any of the preceding items, wherein the step of executing the distributed system state estimation in the primary process is performed upon every reception of periodic measurements.
9. The method according to any of the preceding items, wherein the data set comprise active power and/or reactive power and/or voltage magnitude and/or current magnitude and/or current angles and/or voltage angles.
10. The method according to any of the preceding items, wherein the step of executing a distributed system state estimation comprises an estimation of three-phase conditions of the low-voltage network.
11. The method according to any of the preceding items, wherein the step of executing a distributed system state estimation comprises an estimation of voltage phasors and branch current phasors in the plurality of local nodes.
12. The method according to any of the preceding items, wherein the step of executing a distributed system state estimation comprises estimation of voltages and/or currents and/or consumption and/or generation of power in the plurality of local nodes.
13. The method according to any of the preceding items, wherein the step of estimating impacts on the node voltages and/or branch currents in the plurality of local nodes in the secondary process is substantially real-time.
14. The method according to any of the preceding items, wherein the step of estimating impacts on the node voltages and/or branch currents in the plurality of local nodes in the secondary process is performed individually for every change of power operating point and/or other measurable quantity more than a predefined threshold for one of the distributed energy resources and/or for changes of market data and/or weather data and/or traffic data.
15. The method according to any of the preceding items, wherein the step of estimating impacts on the node voltages and/or branch currents in the plurality of local nodes in the secondary process comprises forecasted information.
16. The method according to any of the preceding items, wherein the step of estimating impacts in the secondary process is performed upon execution of the distributed system state estimation in the primary process, thereby re-evaluating the distributed system state estimation for the low-voltage network.
17. The method according to any of the preceding items, wherein the primary process comprises the step of formulating the data set based on the periodic measurements.
18. The method according to any of the preceding items, wherein the secondary process is used to update the data set in the primary process, taking into account operating conditions in the low-voltage network and adding missing data to the data set.
19. The method according to any of the preceding items, wherein the periodic and/or event-driven measurements are acquired using power line carrier and/or cellular and/or radio frequency communication.
20. The method according to any of the preceding items, wherein the periodic and/or event-driven measurements are acquired in a secondary substation cabinet and wherein the primary and secondary processes are performed in the secondary substation cabinet.
21. The method according to any of the preceding items, further comprising the step of communicating the distribution system conditions to a central entity of a power distribution network operator.
22. A method for monitoring of a low-voltage network of a distribution system comprising the method of estimating distribution system conditions according to any of the preceding items.
23. A computer program having instructions which when executed by a computing device or system causes the computing device or system to perform a distribution system condition estimation according to any of items 1-21.
24. A monitoring system for estimation and monitoring of low-voltage network feeder operating conditions, comprising:
   at least a communication unit configured for:
      acquiring periodic measurements of periodic node voltages and/or branch currents from one or more local nodes in the low-voltage network;
      acquiring event-driven measurements of event-driven node voltages and/or branch currents from one or more distributed energy resources in the low-voltage network;
   at least a processing unit configured for:
      in a primary process, executing a distributed system state estimation for the low-voltage network based on a data set comprising the periodic measurements;
      in a secondary process, estimating impacts on the node voltages and/or branch currents in the local nodes based on the event-driven measurements;
   wherein the estimated impacts on the node voltages and/or branch currents in the local nodes from the secondary process are used to update the data set in the primary process.
25. The monitoring system according to item 24, wherein the system is adapted to be installed in a secondary substation cabinet.
26. The monitoring system according to item 25, wherein the system is installed at the low-voltage side of a distribution transformer of the low-voltage network.
27. The monitoring system according to any of items 24-26 using the method according to any of items 1-21.

1-14. (canceled)

15. A method of estimating distribution system conditions in a low-voltage network of a distribution system, said low-voltage network having a plurality of local nodes, wherein one or more of the local nodes comprise distributed energy resources, the method comprising:
acquiring periodic measurements of periodic node voltages and/or branch currents from one or more of the local nodes in the low-voltage network, wherein the periodic measurements are acquired periodically with fixed time intervals;
acquiring event-driven measurements of event-driven data based on node voltages and/or branch currents from the distributed energy resources and/or other event-driven data sources, wherein the event-driven measurement are acquired when a power operating point and/or other measured quantity changes more than a predefined threshold for one of the distributed energy resources;
in a primary process, executing a distribution system state estimation (DSSE) for the low-voltage network based on a data set comprising the periodic measurements;
in a secondary process, estimating impacts on the node voltages and/or branch currents in the plurality of local nodes based on the event-driven measurements;
wherein the estimated impacts on the node voltages and/or branch currents in the plurality of local nodes from the secondary process are used to update the data set in the primary process.

16. The method according to claim 15, wherein the step of estimating impacts on the node voltages and/or branch currents in the plurality of local nodes comprises estimating voltage magnitude ranges and or branch current ranges for all of the plurality of local nodes.

17. The method according to claim 15, wherein the estimated impacts from the secondary process are used to supplement incomplete data sets in the primary process.

18. The method according to claim 15, wherein the step of executing the distributed system state estimation in the primary process is performed upon every reception of periodic measurements.

19. The method according to claim 15, wherein the step of executing a distributed system state estimation comprises an estimation of three-phase conditions of the low-voltage network.

20. The method according to claim 15, wherein the step of executing a distributed system state estimation comprises an estimation of voltage phasors and branch current phasors in the plurality of local nodes.

21. The method according to claim 15, wherein the step of executing a distributed system state estimation comprises estimation of voltages and/or currents and/or consumption and/or generation of power in the plurality of local nodes.

22. The method according to claim 15, wherein the step of estimating impacts on the node voltages and/or branch currents in the plurality of local nodes in the secondary process is substantially real-time.

23. The method according to claim 15, wherein the step of estimating impacts on the node voltages and/or branch currents in the plurality of local nodes in the secondary process is performed individually for every change of power operating point and/or other measurable quantity more than a predefined threshold for one of the distributed energy resources and/or for changes of market data and/or weather data and/or traffic data.

24. The method according to claim 15, wherein the step of estimating impacts in the secondary process is performed upon execution of the distributed system state estimation in the primary process, thereby re-evaluating the distributed system state estimation for the low-voltage network.

25. The method according to claim 15, wherein the step of estimating impacts on the node voltages and/or branch currents in the plurality of local nodes in the secondary process comprises forecasted information.

26. The method according to claim 15, wherein the step of estimating impacts in the secondary process is performed upon execution of the distributed system state estimation in the primary process, thereby re-evaluating the distributed system state estimation for the low-voltage network.

27. The method according to claim 15, wherein the primary process comprises the step of formulating the data set based on the periodic measurements.

28. The method according to claim 15, wherein the periodic and/or event-driven measurements are acquired using power line carrier and/or cellular and/or radio frequency communication.

29. The method according to claim 15, wherein the secondary process is used to update the data set in the primary process, taking into account operating conditions in the low-voltage network and adding missing data to the data set.

30. The method according to claim 15, wherein the periodic and/or event-driven measurements are acquired in a secondary substation cabinet and wherein the primary and secondary processes are performed in the secondary substation cabinet.

31. A non-transitory storage medium comprising a computer program product having instructions embodied thereon, the computer program product, when executed by a computing device or system, causes the computing device or system to perform a distribution system condition estimation according to claim 15.

32. A monitoring system for estimation and monitoring of low-voltage network feeder operating conditions, comprising:
at least a communication unit configured for:
acquiring periodic measurements of periodic node voltages and/or branch currents from one or more local nodes in the low-voltage network, wherein the periodic measurements are acquired periodically with fixed time intervals;
acquiring event-driven measurements of event-driven node voltages and/or branch currents from one or more distributed energy resources in the low-voltage network, wherein the event-driven measurements are acquired when a power operating point and/or other measured quantity changes more than a predefined threshold for one of the distributed energy resources;
at least a processing unit configured for:
in a primary process, executing a distributed system state estimation (DSSE) for the low-voltage network based on a data set comprising the periodic measurements;
in a secondary process, estimating impacts on the node voltages and/or branch currents in the local nodes based on the event-driven measurements;
wherein the estimated impacts on the node voltages and/or branch currents in the local nodes from the secondary process are used to update the data set in the primary process.
